(19) United States
(12) Patent Application Publication
(10) Pub. No.: US 2022/0324183 A9
(43) Pub. Date: Oct. 13, 2022

(54) FASTENING ELEMENT

(71) Applicant: PROFIL Verbindungstechnik GmbH & Co. KG, Friedrichsdorf (DE)

(72) Inventors: Oliver Diehl, Usingen (DE); Amer Mahlme, Bad Homburg (DE); Tobias Jene, Friedrichsdorf (DE)

(21) Appl. No.: 17/112,405

(22) Filed: Dec. 4, 2020

(30) Foreign Application Priority Data
Dec. 5, 2019 (DE) 102019133230.3

(51) Int. Cl. B29C 65/48; F16B 27/00; B23P 19/06; B29C 65/78; B29C 65/00

(52) U.S. Cl. CPC B29C 65/48; F16B 27/00; B23P 19/062; B29C 65/78; B29C 66/742; F16B 11/006

(57) ABSTRACT

The invention relates to a fastening element for fastening to a workpiece, said fastening element comprising at least a first workpiece element having a first opening and a second workpiece element having a second opening aligned with the first opening, wherein the fastening element has a first contact section having a first contact surface for contact with a region of the first workpiece element surrounding the first opening and a second contact section having a second contact surface for contact with a region of the second workpiece element surrounding the second opening, with the first contact section and the second contact section being connected to one another by means of a reshaping section, and with a rivet section extending from the second contact section in a direction facing away from the reshaping section. The invention further relates to a corresponding component assembly and to a method of manufacturing such a component assembly.

The invention relates to a fastening element for fastening to a workpiece.

Such elements, for example, serve to fasten an object to the workpiece. This is often not directly possible without further ado, in particular if the fastening is to be releasable or if a bonded fastening method is unsuitable. The problem frequently occurs with flat or comparatively thin workpieces, such as sheet metal parts, since they cannot be easily provided with a hole having a loadable internal thread. The solution to this problem is, inter alia, nut or bolt elements that are introduced into the sheet metal part and that have the necessary thread for the fastening of the object. These elements can be introduced into pre-punched holes or can be self-piercing.

It is particularly problematic to provide a fastening possibility at workpieces that comprise a plurality of components, for example two sheet metal parts spaced apart in parallel. On the one hand, the fastening should be reliable and sufficiently loadable for obvious reasons. On the other hand, it must frequently be ensured that the spacing between the components is not reduced by the fastening process.

It is an object of the present invention to provide a fastening element that can be reliably fastened to such a workpiece in a simple manner.

This object is satisfied by a fastening element having the features of claim 1.

In accordance with the invention, the fastening element is suitable and configured to be fastened to a workpiece that comprises at least a first workpiece element having a first opening and a second workpiece element having a second opening aligned with the first opening. The workpiece elements can, for example, be sheet metal parts or components composed of a fiber composite material.

The fastening element has a first contact section having a first contact surface for contact with a region of the first workpiece element surrounding the first opening and a second contact section having a second contact surface for contact with a region of the second workpiece element surrounding the second opening. The contact region of the second workpiece element faces the first workpiece element and the first workpiece element and the second workpiece element are arranged spaced apart from one another, in particular spaced apart in parallel from one another, at least in the regions surrounding the first and second openings.

The first contact section and the second contact section are connected to one another by means of a reshaping section extending in a longitudinal direction of the fastening element. In addition, a rivet section is provided that extends from the second contact section in a direction facing away from the reshaping section.

During the fastening process, the fastening element is introduced into the openings of the workpiece and is reshaped in the region of the reshaping section and of the rivet section in order to provide two form-fitted connections: On the one hand, the first workpiece element is clamped between the first contact surface and a reshaped section of the reshaping section; on the other hand, the second workpiece element is clamped between the second contact surface and a reshaped section of the rivet section. The reshaping section is in this respect in particular designed such that the spacing between the two workpiece elements is also substantially maintained after the fastening process in the same manner in which it was present before the introduction of the fastening element. However, it is also possible that this spacing is “set” for the first time by the fastening process and is in particular reduced by a certain amount.

The reshaping section ultimately bridges the spacing between the two workpiece elements and—in a suitable design—so-to-say acts as a spacer. In an assembled state, the fastening element can therefore also have the effect of stabilizing the workpiece.

The fastening element is preferably at least partly, preferably completely, composed of metal. The use of other materials, for example of a plastic, is likewise possible. The fastening element is in particular formed in one part or in one piece.

Provision can be made that the longitudinal extent of the reshaping section in a state of the fastening element prior to its use is slightly greater than the desired spacing between the workpiece elements since the reshaping of said reshaping section is usually accompanied by a compression in an axial direction.

Further embodiments of the invention are set forth in the claims, in the description, and in the enclosed drawings.

In accordance with an embodiment, the reshaping section and/or the rivet section is/are formed substantially symmetrically, in particular in the shape of a circle, in a cross-section perpendicular to the longitudinal direction. This design facilitates the insertion of the element into the workpiece and reduces the manufacturing costs of the fastening element. However, asymmetrical and/or polygonal cross-sectional shapes can likewise be provided in special cases. In the case of non-circular cross-sections of the reshaping section and/or of the rivet section, a security against rotation of the element already results solely due to its cross-sectional shape.

The reshaping section and/or the rivet section can be arranged coaxially.

In accordance with an embodiment of a simple and compact design, the second contact section is formed at an axial end of the reshaping section remote from the first contact section. The second contact surface is in particular arranged at said end of the reshaping section.

An outer periphery of the rivet section can be smaller than an outer periphery of the reshaping section in order to facilitate the insertion of the fastening element into the workpiece. Alternatively or additionally, a longitudinal extent of the rivet section can be smaller than a longitudinal extent of the reshaping section. As a rule, a comparatively short rivet section is namely sufficient to establish, through its reshaping, a reliable connection to the second workpiece element associated with it. The longitudinal extent of the reshaping section is, in contrast, predefined by the spacing of the workpiece elements that is to be maintained.

A free end of the rivet section can be chamfered to facilitate the penetration of a die provided for its reshaping.

The reshaping section can have a reshaping device that is designed such that a force acting in an axial direction can be converted into a widening of the reshaping section, in particular with the reshaping device having a weakness zone. The reshaping device should in particular ensure that the reshaping section is reshaped in a well-defined manner for the clamping of the fastening element to the first workpiece element. A weakness zone can define where the reshaping starts and can influence its course.

The first contact section, the reshaping section, the second contact section, and/or the rivet section can have a hollow space extending in the longitudinal direction. The respective hollow space can pass through the section associated with it, for example, it can be a passage bore. If two or more of the sections have a hollow space, they can be connected to one another and/or with the hollow spaces being able to be aligned with one another.

The reshaping device is in particular arranged in the hollow space of the reshaping section. For example, the reshaping device is arranged in a hollow space of the reshaping section extending in the longitudinal direction and comprises a step.

The hollow space or the hollow spaces can be at least sectionally cylindrical and/or can at least sectionally have an internal thread.

In accordance with an embodiment, the wall thickness of the reshaping section is not constant, but rather varies in the longitudinal direction. For example, a hollow space of the reshaping section that extends in the longitudinal direction has at least one step and/or one slope—viewed in a longitudinal section including the longitudinal axis of the fastening element. The design of the hollow space can be selected such that it forms the reshaping device (or a part thereof).

The first and/or the second contact surface can be annular. However, other shapes are also conceivable.

In most applications, it is of great importance that the fastening element is reliably fixed to the workpiece. On the one hand, this relates to a fixing in the axial direction, which is brought about by a reshaping of the reshaping section and of the rivet section. On the other hand, the fastening element should, however, also not be able to rotate relative to the workpiece. To achieve a security against rotation, the first and/or the second contact surface can have at least one feature providing security against rotation, in particular one or more ribs extending in a radial direction. Provision can also be made that the first and/or the second contact surface comprises/comprise at least one recess into which material of the respective workpiece element is urged in the fastening process. Such a recess can be an annular groove. The radial ribs mentioned above can, for example, bridge this annular groove to provide a plurality of recesses that provide security against rotation.

Features providing security against rotation (one or more) can also be provided at an outer side of the reshaping section and/or at an outer side of the rivet section, for example, in the form of one or more ribs extending in the axial direction.

In accordance with an embodiment that is simple from a technical manufacturing aspect, the fastening element is formed in one piece. However, it is also by all means conceivable to form it in multiple pieces. For example, the fastening element can comprise a first component that is formed by the first contact section and by a first part of the reshaping section. The second component would then comprise a second part of the reshaping section, the second contact section, and the rivet section. The first part and the second part of the reshaping section can each have an associated coupling section that makes it possible to plug the two parts into one another. Due to a suitable geometrical design of the coupling sections (e.g. complementary slopes), a reshaping device can be provided by which an axial load on the coupling sections is converted into a reshaping, in particular into a widening of the reshaping section.

The fastening element can be a nut element or a bolt element.

The present invention further relates to a component assembly, comprising a workpiece that comprises at least a first workpiece element having a first opening and a second workpiece element having a second opening aligned with the first opening, wherein the first workpiece element and the second workpiece element are arranged spaced apart from one another, in particular spaced apart in parallel from one another, at least in a respective region surrounding the first and second openings, and wherein the region of the second workpiece element faces the first workpiece element. The component assembly additionally comprises at least one fastening element, in particular in accordance with any one of the above-described embodiments, having a first contact section having a first contact surface for contact with the region of the first workpiece element surrounding the first opening and having a second contact section having a second contact surface for contact with the region of the second workpiece element surrounding the second opening. The first contact section and the second contact section are connected to one another by means of a reshaping section extending in the longitudinal direction of the fastening element. A rivet section extends from the second contact section in a direction facing away from the reshaping section.

The reshaping section is at least sectionally widened such that the first workpiece element is clamped between the first contact surface and a widened portion of the reshaping section. The rivet section is at least sectionally widened such that the second workpiece element is clamped between the second contact surface and a widened portion of the rivet section.

In accordance with an embodiment of the component assembly, the rivet section is widened such that the second workpiece element is clamped in a manner secure against rotation between the second contact surface and the widened portion of the rivet section. The clamping between the first contact surface and the widened portion of the reshaping section can be designed such that the first workpiece element is rotatable with respect to the fastening element fixedly connected to the second workpiece element. In this respect, the widened portion of the reshaping section is sufficiently large that the second workpiece element is captively secured to the fastening element, viewed in the axial direction of said fastening element. A design of the component assembly that is reversed with respect to the two clampings is also conceivable.

Alternatively to the above-described embodiment of the component assembly, both clampings can also be designed such that they provide a rotatable fastening or a fastening secure against rotation of the respective workpiece to the fastening element.

In accordance with an embodiment, the second opening is smaller than the first opening.

The spacing of the region of the first workpiece element surrounding the first opening from the region of the second workpiece element surrounding the second opening can be smaller than a longitudinal extent of the reshaping section before the fastening of the fastening element to the workpiece.

A further aspect of the present invention relates to a method of manufacturing a component assembly in accordance with any one of the above-described embodiments. The fastening element is introduced in the longitudinal direction of the fastening element first into the opening of the first workpiece element and then into the opening of the second workpiece element by means of a setting device by a setting movement that comprises at least a first movement phase and a second movement phase. The rivet section cooperates with a die during the first movement phase in order to widen the rivet section, wherein the die is arranged at the side of the second workpiece element remote from the first workpiece element. A widening of the reshaping section is brought about during the second movement phase, in particular with the widening being brought about by an axial compression of the reshaping section.

The widening of the reshaping section and the widening of the rivet section can take place offset in time and/or the first movement phase and the second movement phase can be offset in time.

The first movement phase and the second movement phase are in particular coordinated with one another such that the widening of the reshaping section only starts after the widening of the rivet section has started. This means that the second movement phase only starts after the start of the first movement phase. In certain cases, it can be advantageous if the second movement phase starts toward the end of the first movement phase or even after its completion.

It is also conceivable to coordinate the first movement phase and the second movement phase with one another such that the widening of the reshaping section only starts after the second contact surface has been brought into contact with the region of the second workpiece surrounding the second opening.

The first movement phase and the second movement phase can merge into one another or can overlap partly or completely.

To simplify the setting movement, the first movement phase and the second movement phase can be coaxial movements and/or can have the same direction of movement.

In accordance with an embodiment of the method, the setting device has a punch that projects into a hollow space of the reshaping section extending in the longitudinal direction and that cooperates with a reshaping device in order to widen the reshaping section.

The reshaping device can comprise at least one step that cooperates with the punch, in particular via a slope formed at the punch or a conically shaped punch surface, in order to widen the reshaping section. A relative movement of the punch and the reshaping section has the effect that the step is urged outwardly in the radial direction by the running up at the slope or at the conical punch surface. This ultimately has the result that the reshaping section is thus widened. A design of the reshaping device as a step is associated with the advantage that a line contact is present between an edge formed by the step and the punch surface, said line contact only causing a comparatively low friction, on the one hand, but ensuring a good force transmission, on the other hand.

The punch can be rigidly arranged or can be moved relative to a section of the setting device cooperating with the first contact section in the longitudinal direction of the fastening element in order to bring about the second movement phase.

The design of the second movement phase has effects on the manner of the clamping of the first workpiece element to the fastening element. The magnitude of the axial compression of the reshaping section and/or—if provided—the penetration depth and/or the design of the punch and the manner of its cooperation with the reshaping device can result in a widening of the reshaping section that indeed secures the first workpiece at the fastening element, but allows a relative rotation of the two components. In simplified terms, a less strong clamping results in a design of the connection in which the fastening element acts as a pivot point for the first workpiece, but which simultaneously secures the first workpiece at the fastening element (viewed in the axial direction of the fastening element). Alternatively, a clamping in a manner secure against rotation of the first workpiece to the fastening element can, however, also be realized.

The same applies analogously to the first movement phase or to the design of the die and to the thereby produced clamping of the second workpiece to the fastening element by widening the rivet section.

The present invention will be explained in the following purely by way of example with reference to advantageous embodiments and to the enclosed drawings. There are shown:

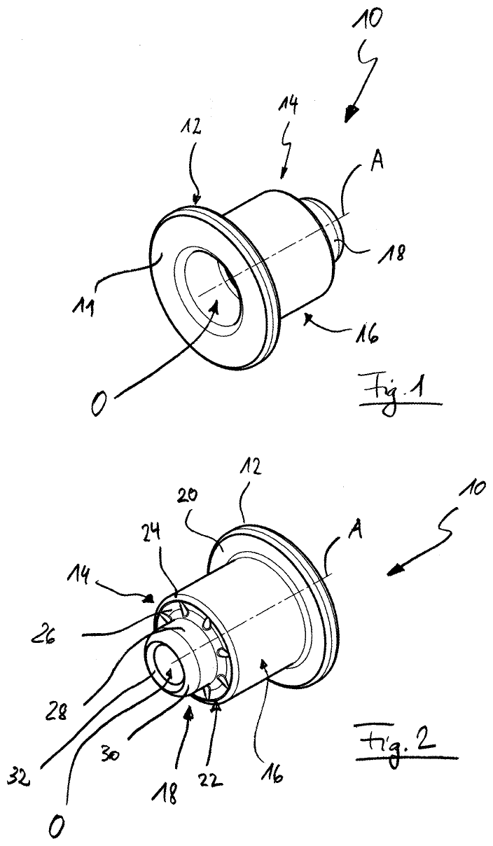

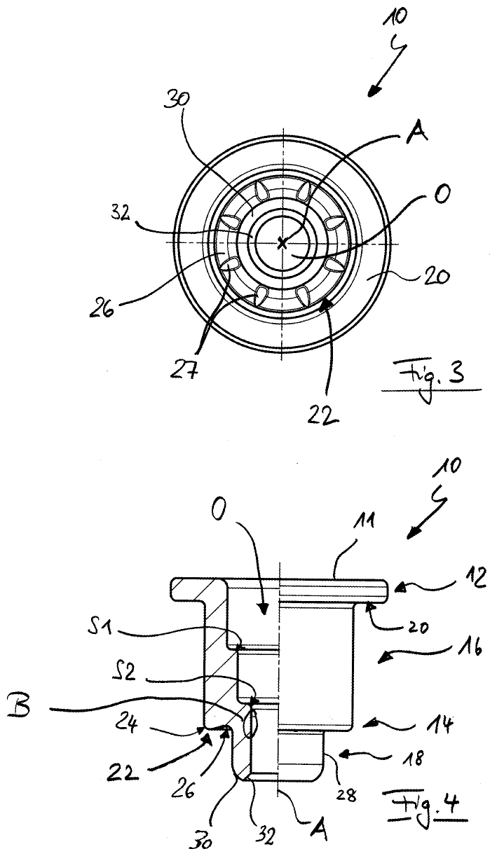

FIGS. 1 and 2 a first embodiment of the fastening element in accordance with the invention in a perspective view in each case;

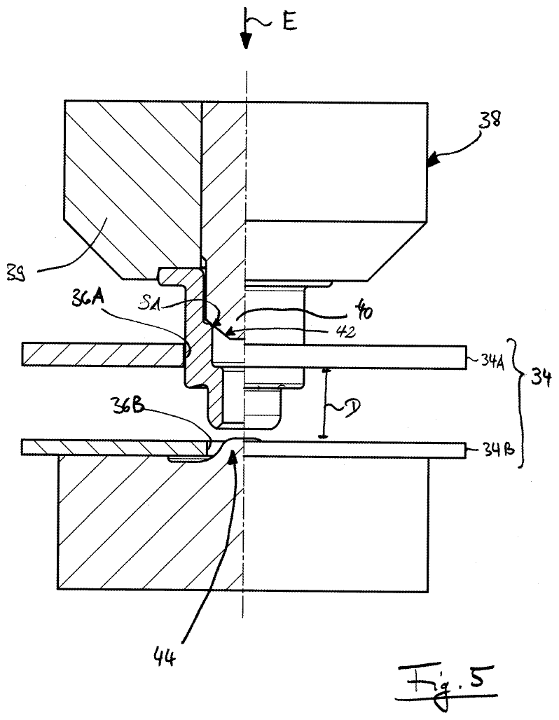

FIG. 3 the fastening element in accordance with the first embodiment in an axial view;

FIG. 4 the fastening element in accordance with the first embodiment in a longitudinal section or in a side view;

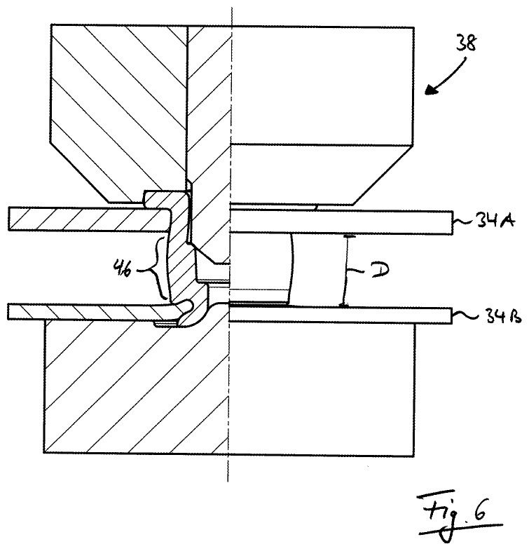

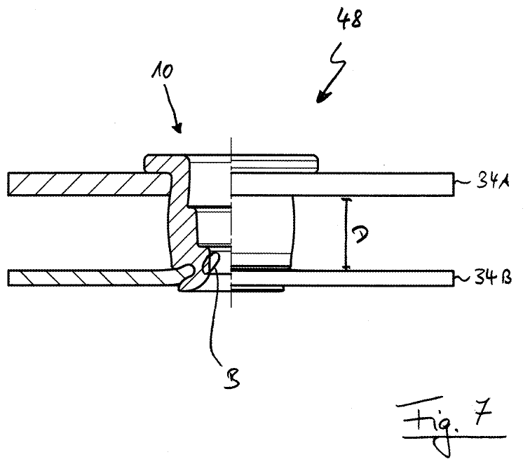

FIGS. 5 and 6 the process of inserting the fastening element in accordance with the first embodiment into a workpiece;

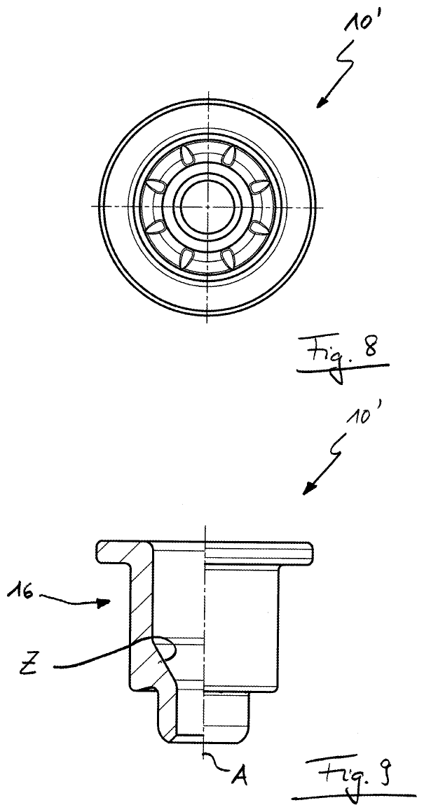

FIG. 7 the fastening element in accordance with the first embodiment in a state fixed to the workpiece (component assembly);

FIG. 8 the fastening element in accordance with the second embodiment in an axial view;

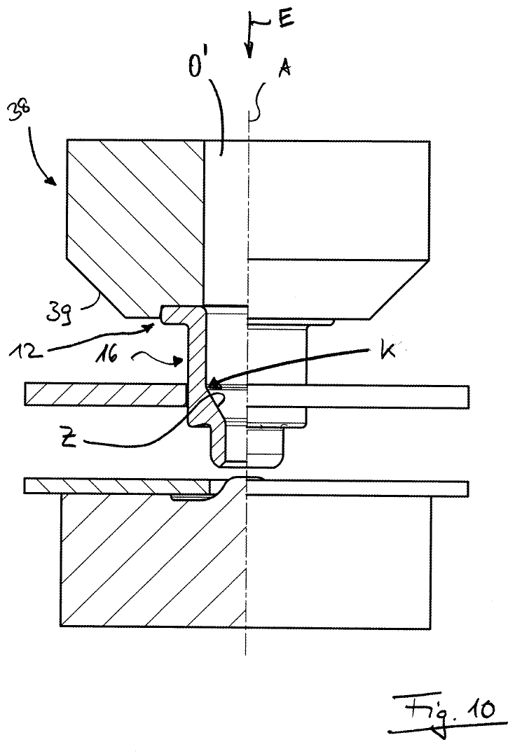

FIG. 9 the fastening element in accordance with the second embodiment in a longitudinal section or in a side view;

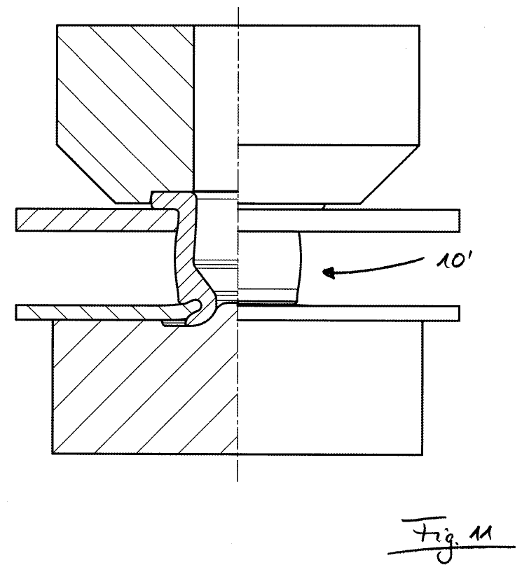

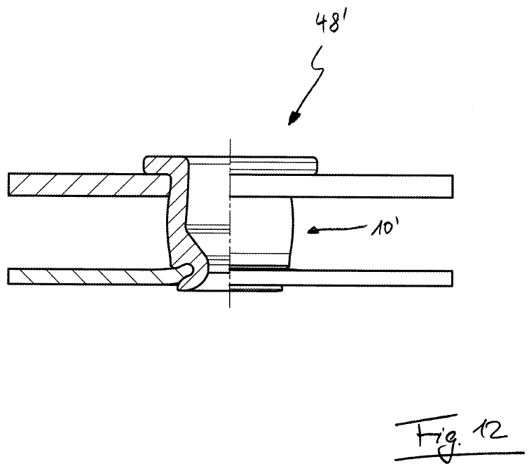

FIGS. 10 and 11 the process of inserting the fastening element in accordance with the second embodiment into a workpiece; and

FIG. 12 the fastening element in accordance with the second embodiment in a state fixed to the workpiece (component assembly).

FIGS. 1 and 2 show a first embodiment 10 of the fastening element in accordance with the invention. The element 10 has a central opening O and is—here by way of example—rotationally symmetrical about a longitudinal axis A and comprises a flange-like first contact section 12 and a second contact section 14. A reshaping section 16 extends between the contact sections 12, 14. A rivet section 18 extends from the contact section 14 in a direction that faces away from the reshaping section 16.

A contact surface 20 of the contact section 12 facing the reshaping section 16 serves for contact with a first component of a workpiece. The contact surface 20 is designed in an annular and substantially planar manner. Contrary to what is shown, it can also be provided with elevated portions and/or recesses that, on contact with said component, counteract a rotation of the element 10. A flange surface 11 is arranged at the side of the contact section 12 opposite the contact surface 20 and cooperates with a setting device, not shown, in a setting process.

The outer surface of the reshaping section 16 has a cylindrical base shape. If necessary, it can likewise be provided with features providing security against rotation that cooperate with walls of a hole in the first workpiece component. Such features providing security against rotation can, for example, be ribs (not shown) that extend in the axial direction of the reshaping section 16.

The contact section 14, which—like the contact section 12—is substantially annular, and a contact surface 22 for contact with a second component of the workpiece arranged spaced apart from the first component are arranged at the axial end of the reshaping section 16 remote from the contact section 12. To facilitate the introduction of the reshaping section 16 into a hole of the first component of the workpiece, the reshaping section 16 is provided with a (curved) chamfer 24. The contact surface 22 has an annular groove 26 that is bridged by ribs 27 extending in the radial direction. The ribs 28 are preferably uniformly distributed in the peripheral direction. It is understood that the features described with respect to the contact surface 22 can also be present at the contact surface 20 (and vice versa) if this should be necessary in the respective present application.

The rivet section 18 has a cylindrical base body 28 that merges into a curved end section 30 toward the free ends of the rivet section 18. The end section 30 can also have a slope. The end section 30 forms an introduction aid for inserting the rivet section 18 into a hole of the second workpiece component. The free end of the rivet section 18 is provided with a chamfer 32 around the opening O to facilitate the introduction of a die, not shown, into the rivet section 18.

FIG. 3 shows the element 10 in an axial view with a view of the contact surfaces 20, 22, whereby the rotationally symmetrical design of the element 10 can easily be recognized. In general, the contact surfaces 20, 22, the reshaping section 16, and/or the rivet section 18 can have other contours or cross-sections, e.g. oval or polygonal contours or cross-sections.

FIG. 4 shows a longitudinal section (left of the axis A) and a side view (right of the axis A) of the element 10. It can be recognized in the longitudinal section that the central opening O does not have a constant diameter. It has two steps S1, S2, whereby the diameter decreases, viewed from the contact section 12. For example, an internal thread can be provided in a region B below the step S2 and can serve for the connection to an object that should be coupled to the workpiece.

The opening O can also be considered as a combination of a plurality of mutually connected and mutually aligned hollow spaces of the sections 12, 14, 16, 18 that each do not necessarily have to have a constant diameter.

How the element 10 is fastened to a workpiece 34 will now be illustrated with reference to FIGS. 5 and 6. The workpiece 34 comprises two components 34A, 34B that, in the present example, are of different thicknesses and are arranged spaced apart in parallel from one another. It is understood that the components 34A, 34B can generally be of any desired design. In the context of the present invention, it is merely essential that they do not directly contact one another in regions around holes 36A, 36B in the components 34A and 34B that receive the element 10, but rather that a spacing D is present between the regions. The material of the components 34A, 34B can also be freely selected.

With the aid of a setting device 38 that engages at the flange surface 11 by means of a setting head 39 and that has a punch 40 that is fixedly connected to the setting head 39 and that projects into the opening O, the element 10 is first introduced into the hole 36A in a straight-line setting movement E. A conically shaped punch surface 42 contacts the step S1 in this respect. No deformation of the element 10 initially takes place.

Finally, the free end of the rivet section 18 penetrates into a gap between the margin of the hole 36B and a die 44 provided to reshape the rivet section 18. The introduction of the rivet section 18 into the hole 36B is promoted by the design of the end section 30. The chamfer 32 in turn facilitates the penetration of the die 44 into the lower end of the opening O.

As soon as the rivet section 18 comes into contact with the die 44 in the course of the setting movement E, its reshaping starts. It is bent over outwardly due to the shape of the die 44 and thus engages behind the workpiece 34B. On a progression of the setting movement E, the contact surface 22 comes into contact with the surface of workpiece component 36B facing the workpiece component 34A in a region around the hole 36B (see FIG. 6). The setting movement E therefore ultimately has the result that the rivet section 18 is supported on the die, while the contact surface 22 is pressed against the component 34B from above so that the region around the hole 36B is pressed into the annular groove 26.

However, the setting movement E not only results in a reshaping of the rivet section 18, but also in a widening of the reshaping section 16. When this starts, depends—in addition to the properties of the material of the element 10—also on its geometric design. As soon as the rivet section 18 namely cooperates with the die 44, a force occurs that counteracts the setting movement E. The conical punch surface 42 then cooperates with the step S1 and urges it outwardly on the progression of the movement E, whereby the reshaping section 18 forms a bulge. Due to this bulge 46, which can be easily seen in FIG. 6, a clamping connection is produced. In other words, the workpiece component 34A is clamped between the contact surface 20 and the bulge 46. The settling movement E is completed when the desired axial compression of the reshaping section 16 has been achieved and the contact surface 20 securely contacts the surface of the component 34A. The setting device 38 can then be removed.

The result of the above-described setting process, namely a component assembly 48 comprising the workpiece 34 having the components 34A, 34B and the element 10 reliably fastened thereto, is shown in FIG. 7. It can be recognized that the setting process did not result in a substantial change of the spacing D. An object can now be fastened to the workpiece 34 in a simple manner, for example, by means of a bolt. Due to the bulge 46 and the support of the reshaping section 16 on the workpiece component 34B, the element 10 acts as a stabilizing spacer.

Since the reshaping section 16 is compressed in the axial direction during the setting process, the spacing between the surfaces 20, 22 in an undeformed element 10 is slightly greater than the spacing D. This oversize corresponds to the axial compression. In general, it is also possible not to provide an oversize or even to provide an undersize if a reduction of the spacing D in the region of the holes 36A, 36B is deliberately intended to be achieved.

When the creation of the bulge 46 starts and how pronounced it is depends, among other things, on the geometry of the die, on the amplitude of the setting movement E, on the stability or the wall thickness of the reshaping section 16, and on the design of the step S1 and of the punch surface 42. These parameters are freely selectable and can be adapted to the respective present demands. The decisive factor is at what point in time the force directed against the setting movement E is so great that the radial force generated by the cooperation of the punch surface 42 with the step S1 exceeds the stability of the wall of the section 16 so that the widening of said section 16 starts. This point in time can be reached as soon as a reshaping of the rivet section 18 starts or a certain degree of reshaping of the rivet section 18 is achieved, for example, as soon as it sufficiently engages behind the component 34B so that an axial support is ensured. However, it can also be the point in time at which the contact surface 22 comes into contact with the surface of the component 34B. The element 10 can also be designed such that the two conditions occur substantially simultaneously. The reshaping of the reshaping section 18 can also only start when the reshaping of the rivet section 16 has already been substantially completed.

In other words: The setting process comprises at least two phases that are associated with the reshaping of the rivet section 18 (phase P1), on the one hand, and with the widening of the reshaping section 16 (phase P1), on the other hand. These two phases can be separated in time, can merge into one another or can at least partly overlap. In the above-described example, the phases P1, P2 overlap. The phase P1 starts before the phase P2 that, however, ends after the phase P1. In this respect, the setting movement E is a continuous linear movement in the present example. However, it is conceivable to provide a movement E that varies in time. The use of a punch 40 that is movable relative to the setting head 39 and that produces the deformation of the reshaping section 16 through its own movement, e.g. through an impact movement after the completion of a reshaping of the rivet section 18, is also conceivable.

A further embodiment 10′ of the fastening element in accordance with the invention will be described with reference to the following FIGS. 8 to 12. Externally, it resembles the element 10′ so that perspective views are omitted. There are also no decisive differences in the axial view (cf. FIG. 8).

It can, in contrast, be recognized from FIG. 9 that a slope Z (cf. the longitudinal section to the left of the axis A) is provided instead of the steps S1, S2 of the element 10. The element 10′ does not require a punch 40, as can be seen from FIGS. 10 and 11. The component assembly 48′ obtained by the setting process shown in FIGS. 10 and 11 is shown in FIG. 12.

The reshaping of the section 16 also takes place here if the force opposite to the setting movement E (e.g. generated by the reshaping of the rivet section 18) exceeds the stability of the wall of the reshaping section 16. A kink K between the otherwise cylindrical inner wall of the section 16 and the slope Z functionally forms a weakness zone that determines the start of the widening. The geometry of the slope Z (e.g. the inclination, the axial position, . . . ) and the wall thickness at a region disposed axially above the slope Z thus form a kind of reshaping device that produces the desired widening without an additional punch if a threshold value of an axial load is exceeded.

Since a punch can be dispensed with, the concept of the element 10′ is well suited for bolt elements. With said bolt elements, a bolt section of the element can project upwardly from the contact section 12 into a central opening O′ of the setting head 39.

### REFERENCE NUMERAL LIST

10, 10′ fastening element
11 flange surface
12, 14 contact section
16 reshaping section
18 rivet section
20, 22 contact surface
24, 32 chamfer
26 annular groove
27 rib
28 cylindrical base body
30 end section
34 workpiece
34A, 34B workpiece component
36A, 36B hole
38 setting device
39 setting head
40 punch
42 punch surface
44 die
46 bulge
48, 48′ component assembly
A longitudinal axis
O, O′ central opening
D spacing
S1, S2 step
B threaded region
E setting movement
Z slope
K kink

1. A fastening element for fastening to a workpiece, said fastening element comprising:
at least a first workpiece element having a first opening and
a second workpiece element having a second opening aligned with the first opening,
wherein the fastening element has a first contact section having a first contact surface for contact with a region of the first workpiece element surrounding the first opening and a second contact section having a second contact surface for contact with a region of the second workpiece element surrounding the second opening,
wherein the region of the second workpiece element faces the first workpiece element, and wherein the first workpiece element and the second workpiece element are arranged spaced apart from one another at least in the regions surrounding the first and second openings,
with the first contact section and the second contact section being connected to one another by means of a reshaping section extending in a longitudinal direction of the fastening element, and
with a rivet section extending from the second contact section in a direction facing away from the reshaping section.

2. The fastening element in accordance with claim 1,
wherein at least one of the reshaping section and the rivet section is formed substantially symmetrically in a cross-section perpendicular to the longitudinal direction.

3. The fastening element in accordance with claim 1,
wherein at least one of the reshaping section and the rivet section is arranged coaxially.

4. The fastening element in accordance with claim 1,
wherein the second contact section is formed at an axial end of the reshaping section remote from the first contact section.

5. The fastening element in accordance with claim 1,
wherein an outer periphery of the rivet section is smaller than an outer periphery of the reshaping section; and/or wherein a longitudinal extent of the rivet section is smaller than a longitudinal extent of the reshaping section.

6. The fastening element in accordance with claim 1,
wherein a free end of the rivet section is chamfered.

7. The fastening element in accordance with claim 1,
wherein the reshaping section has a reshaping device that is designed such that a force acting in an axial direction can be converted into a widening of the reshaping section.

8. The fastening element in accordance with claim 1,
wherein at least one of the first contact section, the reshaping section, the second contact section, and the rivet section has a hollow space extending in the longitudinal direction.

9. The fastening element in accordance with claim 8,
wherein the reshaping device is arranged in the hollow space of the reshaping section.

10. The fastening element in accordance with claim 7,
wherein the reshaping device is arranged in a hollow space of the reshaping section extending in the longitudinal direction, and wherein the reshaping device comprises at least one step.

11. The fastening element in accordance with claim 8,
wherein the hollow space is at least sectionally cylindrical and/or at least sectionally has an internal thread.

12. The fastening element in accordance with claim 8,
wherein a wall thickness of the reshaping section varies in the longitudinal direction.

13. The fastening element in accordance with claim 1,
wherein at least one of the first contact surface and the second contact surface is annular.

14. The fastening element in accordance with claim 1,
wherein at least one of the first contact surface and the second contact surface has at least one feature providing security against rotation.

15. The fastening element in accordance with claim 1,
wherein at least one of the first contact surface and the second contact surface comprises at least one recess.

16. The fastening element in accordance with claim 1,
wherein at least one of an outer side of the reshaping section and an outer side of the rivet section has at least one feature providing security against rotation.

17. The fastening element in accordance with claim 1,
wherein the fastening element is formed in one piece.

18. The fastening element in accordance with claim 1,
wherein the fastening element is one of a nut element and a bolt element.

19. A component assembly, comprising:
a workpiece that comprises at least a first workpiece element having a first opening and a second workpiece element having a second opening aligned with the first opening, wherein the first workpiece element and the second workpiece element are arranged spaced apart from one another at least in a respective region surrounding the first and second openings, and wherein the region of the second workpiece element faces the first workpiece element; and
a fastening element having a first contact section having a first contact surface for contact with the region of the first workpiece element surrounding the first opening and having a second contact section having a second contact surface for contact with the region of the second workpiece element surrounding the second opening, wherein the first contact section and the second contact section are connected to one another by means of a reshaping section extending in the longitudinal direction of the fastening element, and wherein a rivet section extends from the second contact section in a direction facing away from the reshaping section,
wherein the reshaping section is at least sectionally widened such that the first workpiece element is clamped between the first contact surface and a widened portion of the reshaping section, and
wherein the rivet section is at least sectionally widened such that the second workpiece element is clamped between the second contact surface and a widened portion of the rivet section.

20. The component assembly in accordance with claim 19,
wherein the second opening is smaller than the first opening.

21. The component assembly in accordance with claim 19,
wherein the spacing of the region of the first workpiece element surrounding the first opening from the region of the second workpiece element surrounding the second opening is smaller than a longitudinal extent of the reshaping section before the fastening of the fastening element to the workpiece.

22. A method of manufacturing a component assembly, the component assembly comprising:
a workpiece that comprises at least a first workpiece element having a first opening and a second workpiece element having a second opening aligned with the first opening, wherein the first workpiece element and the second workpiece element are arranged spaced apart from one another at least in a respective region surrounding the first and second openings, and wherein the region of the second workpiece element faces the first workpiece element; and
a fastening element having a first contact section having a first contact surface for contact with the region of the first workpiece element surrounding the first opening and having a second contact section having a second contact surface for contact with the region of the second workpiece element surrounding the second opening, wherein the first contact section and the second contact section are connected to one another by means of a reshaping section extending in the longitudinal direction of the fastening element, and wherein a rivet section extends from the second contact section in a direction facing away from the reshaping section,
wherein the reshaping section is at least sectionally widened such that the first workpiece element is clamped between the first contact surface and a widened portion of the reshaping section, and
wherein the rivet section is at least sectionally widened such that the second workpiece element is clamped between the second contact surface and a widened portion of the rivet section,
wherein the fastening element is introduced in the longitudinal direction of the fastening element first into the opening of the first workpiece element and then into the opening of the second workpiece element by means of a setting device by a setting movement that comprises at least a first movement phase and a second movement phase, wherein the rivet section cooperates with a die during the first movement phase in order to widen the rivet section, wherein the die is arranged at the side of the second workpiece element remote from the first workpiece element, and wherein a widening of the reshaping section is brought about during the second movement phase.

23. The method in accordance with claim 22,
wherein the widening of the reshaping section and the widening of the rivet section take place offset in time and/or the first movement phase and the second movement phase are offset in time; and/or
wherein the first movement phase and the second movement phase are coordinated with one another such that the widening of the reshaping section only starts after the widening of the rivet section has started or has been completed; and/or
wherein the first movement phase and the second movement phase are coordinated with one another such that the widening of the reshaping section only starts after the second contact surface has been brought into contact with the region of the second workpiece surrounding the second opening; and/or
wherein the first movement phase and the second movement phase merge into one another or overlap partly or completely; and/or
wherein the first movement phase and the second movement phase are coaxial movements and/or have the same direction of movement; and/or
wherein the setting device has a punch that projects into a hollow space of the reshaping section extending in the longitudinal direction and that cooperates with a reshaping device in order to widen the reshaping section; and/or
wherein the reshaping device comprises at least one step that cooperates with the punch; and/or
wherein the punch is moved relative to a section of the setting device cooperating with the first contact section in the longitudinal direction of the fastening element in order to bring about the second movement phase.
